(19) United States
(12) Patent Application Publication
(10) Pub. No.: US 2012/0059290 A1
(43) Pub. Date: Mar. 8, 2012

(54) WEARABLE DEVICE FOR FINGER REHABILITATION

(76) Inventor: Joanne Yiu Wan YIP, Hong Kong (HK)

(21) Appl. No.: 12/874,777

(22) Filed: Sep. 2, 2010

(51) Int. Cl. A61H 1/02

(52) U.S. Cl. 601/40

(57) ABSTRACT

A wearable device (10) for daily finger rehabilitation, the device (10) comprising: a textile material (20); and electroactive polymer (EAP) matrix sets (30) operatively connected to the textile material (20) to form an EAP actuator for a finger (5); wherein at least one EAP matrix set (30) corresponds to a finger joint of the finger (5) for movement of the finger about the finger joint.

### TECHNICAL FIELD

The invention concerns a wearable device for finger rehabilitation.

### BACKGROUND OF THE INVENTION

Strokes are a major cause of permanent disability in adults. Stroke survivors experience upper extremity dysfunction, and distal limb impairment is prevalent. This is especially problematic because proper hand function is crucial to manual exploration and manipulation of the environment. Moreover, loss of hand function is a major source of impairment in neuromuscular disorders, frequently preventing effective occupational performance and independent participation in daily life. Post-stroke rehabilitation plays a crucial role in helping stroke patients reduce their symptoms of discomfort and restore their motor functions. Repetitive generic movement exercises can help improve the ability of patients to carry out a wide range of daily motor tasks. Basically, there are three main types of post-stroke rehabilitation. “Passive movement” (or externally imposed), involves movement of the joint by a therapist as the patient remains relaxed. “Active-assisted movement” is used when the patient cannot complete a desired movement independently. During attempts by the patient to move a joint or limb, external assistance forces are applied as needed; and “active-resisted movement” which is used by higher level patients, involves completing movements against resistance from gravity through additional weights, an elastic band, or the therapist. Among these three treatments, active-assisted movement is proven to have positive effects on a large number of acute stroke patients. The patients significantly decrease arm impairment.

In prior decades, post-stroke rehabilitation programmes were seen as time consuming and labour demanding because therapists and patients needed one-to-one manual interaction. Therefore, robotic devices to assist therapists, are in great demand. The robotic devices can assist the therapists in conducting intensive and safe rehabilitation programmes with more quantitative and reproducible training motions. Certain robotic devices have been developed especially for shoulder, elbow and wrist rehabilitation. However, devices for finger rehabilitation are still very limited. Traditionally, finger rehabilitation is executed manually and mainly focused on sensory re-education. Apparently, stroke patients lack finger muscle training. In the market, there are some tools, such as iron/plastic dumb-bells or wooden rocks for less severe stroke patients to practice their finger mobility in a self help manner. As for acute stroke patients, these devices are not suitable due to the motor disability of the patients.

There is a desire to optimize finger muscle training for stroke patients using a robotic device which allows patients to have daily treatment without frequent assistance from therapists. Prior robotic devices used actuator materials like peizoceramics or shape memory alloys. These materials are not suitable because they are not flexible and induce high temperature.

### SUMMARY OF THE INVENTION

In a first preferred aspect, there is provided a wearable device for daily finger rehabilitation, the device comprising:
a textile material; and
electroactive polymer (EAP) matrix sets operatively connected to the textile material to form an EAP actuator for a finger;
wherein at least one EAP matrix set corresponds to a finger joint of the finger for movement of the finger about the finger joint.

The wearable device may further comprise five finger sheaths and wherein each finger sheath has EAP matrix sets corresponding to all the finger joints of a finger to assist each muscle of the finger.

The EAP matrix sets may be ionic or electronic.

Each finger of the wearer may have a corresponding EAP actuator.

Each EAP actuator may be individually controlled by software

Each EAP actuator may be connected by a wire to an electrical power source and controlled by a computer.

The textile material may be made from any one from the group consisting of: cotton, nylon, polyester and spandex.

The EAP matrix sets may be thread stitched to the textile material to operatively connect the EAP matrix sets to the textile material.

The EAP matrix sets may completely surround the textile material or cover a single surface of the textile material.

The wearable device may be in the form of a glove.

### BRIEF DESCRIPTION OF THE DRAWINGS

An example of the invention will now be described with reference to the accompanying drawings, in which:

FIG. 1 is a cross-sectional side view of a hand inserted into an EAP glove with one EAP matrix set according to an embodiment of the present invention; and

FIG. 2 is a top plan view of the EAP glove of FIG. 1;

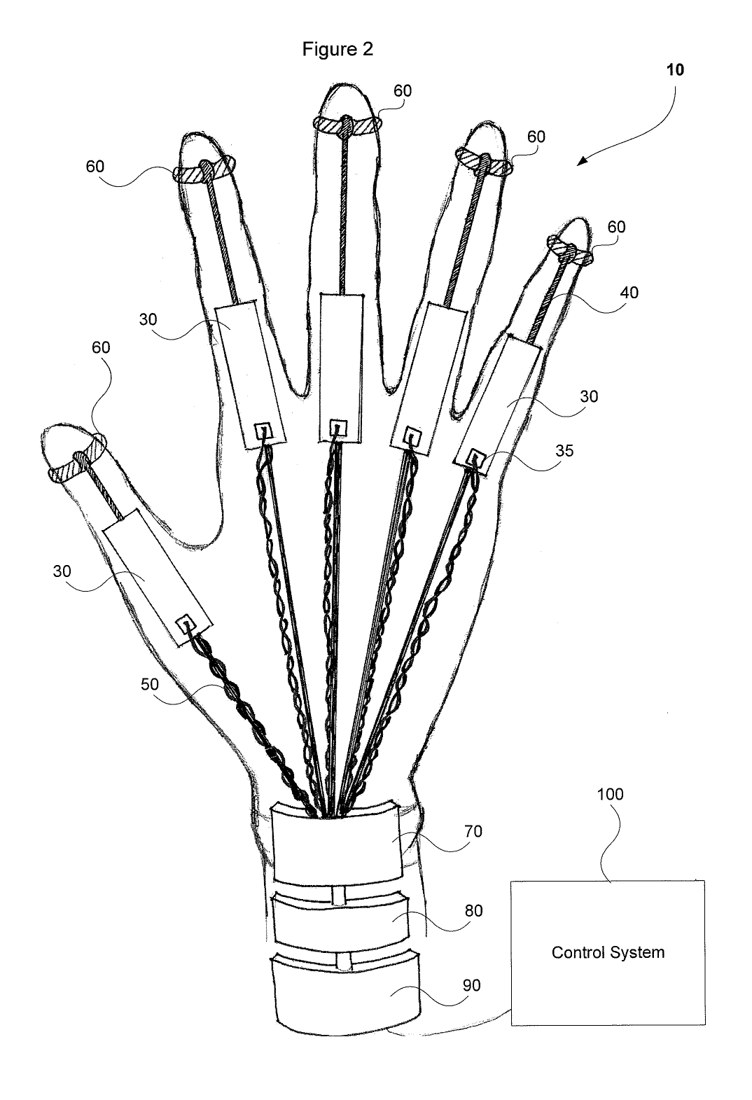

FIG. 3 is a perspective view from above of the EAP glove of FIG. 1;

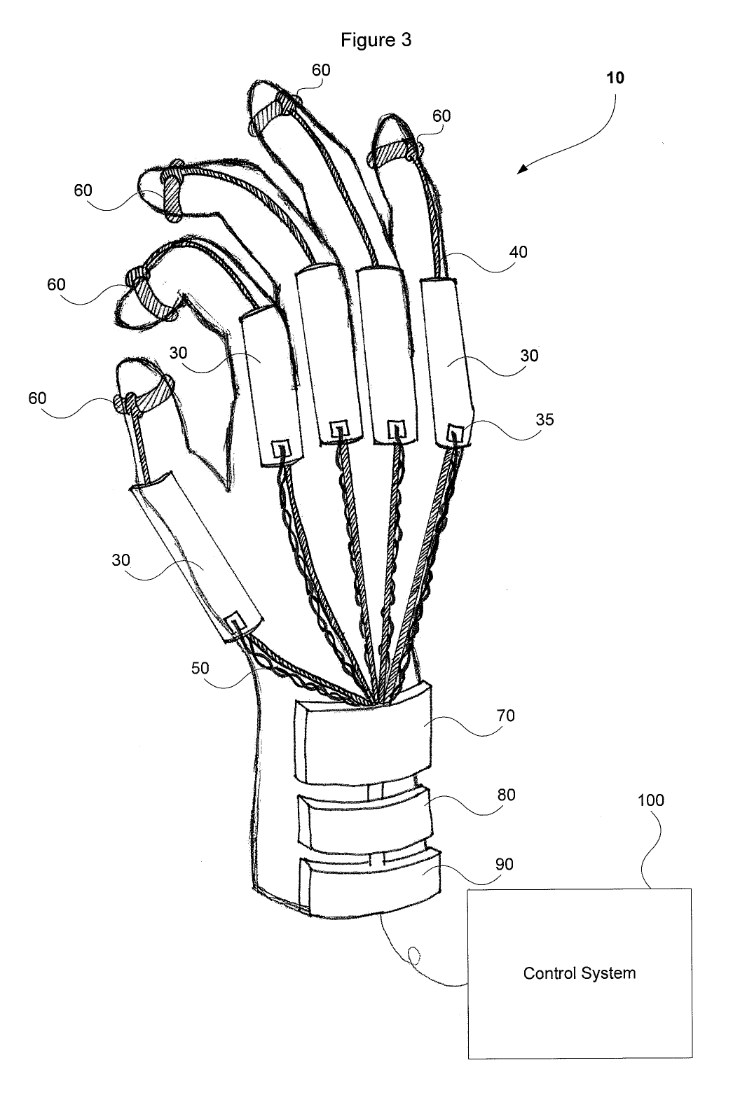

FIG. 4 is a sectional side view of another EAP glove with two EAP matrix sets according to an embodiment of the present invention;

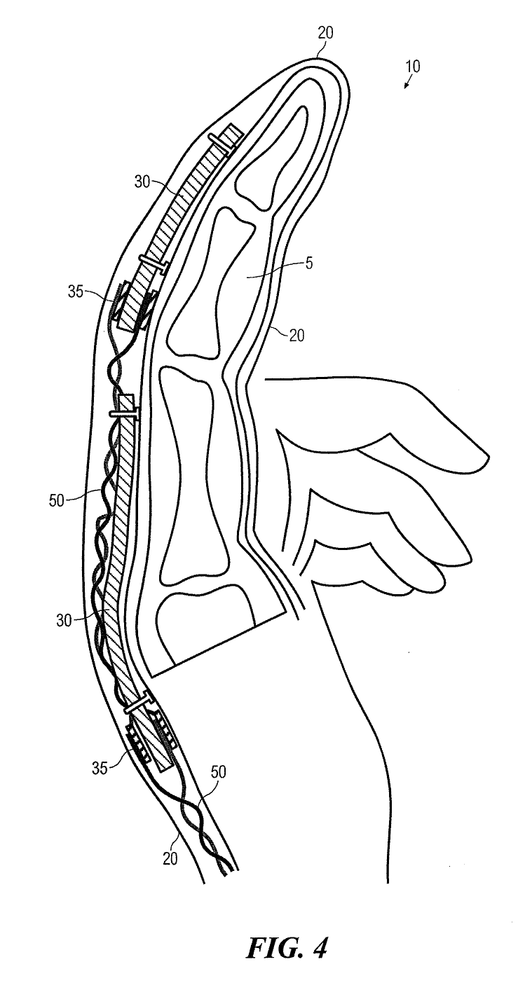

FIG. 5 is a top plan view of the EAP glove of FIG. 4;

FIG. 6 is a perspective view from above of the EAP glove of FIG. 4;

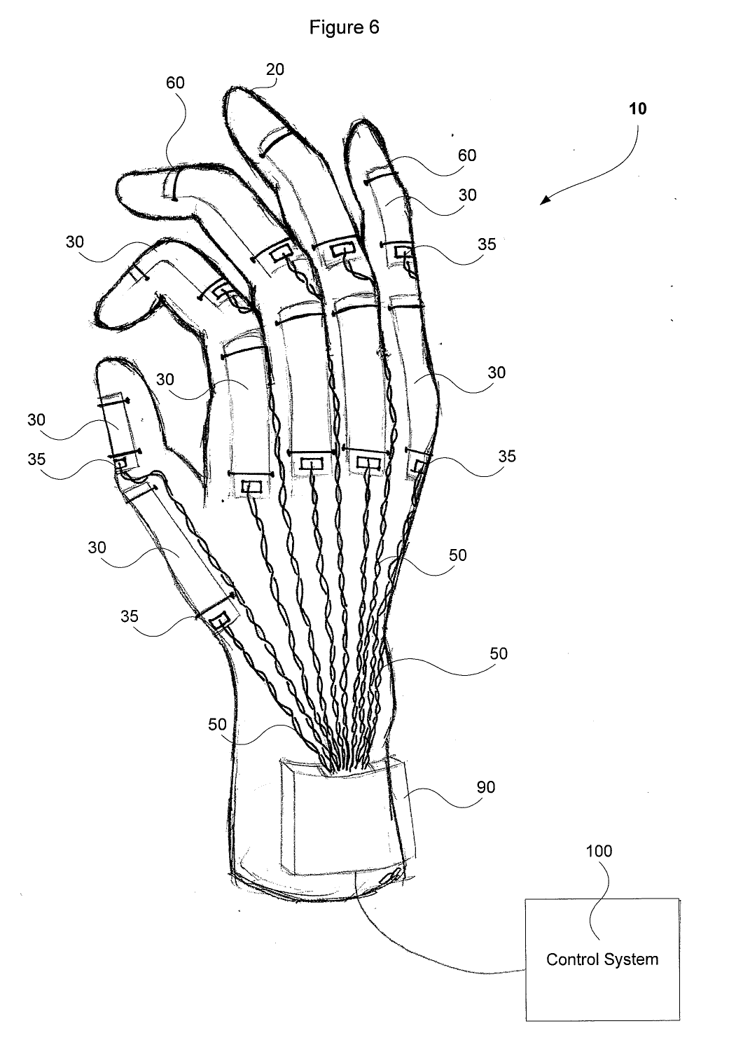

### DETAILED DESCRIPTION OF THE DRAWINGS

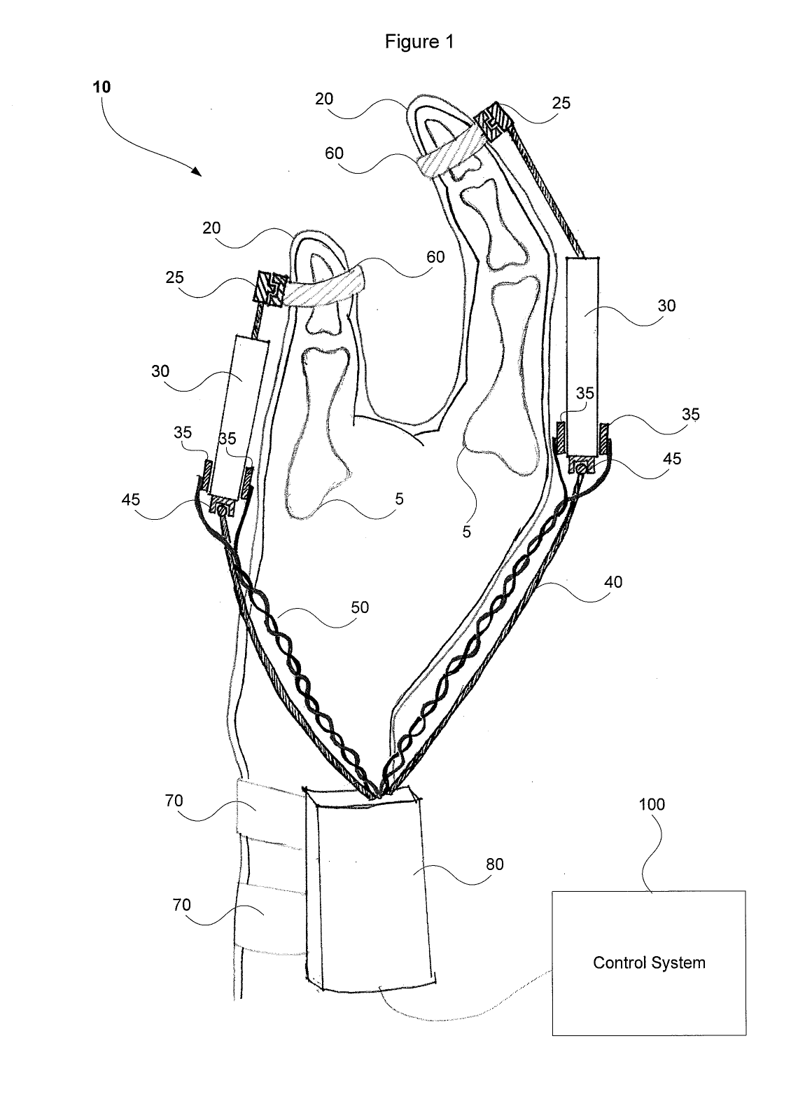

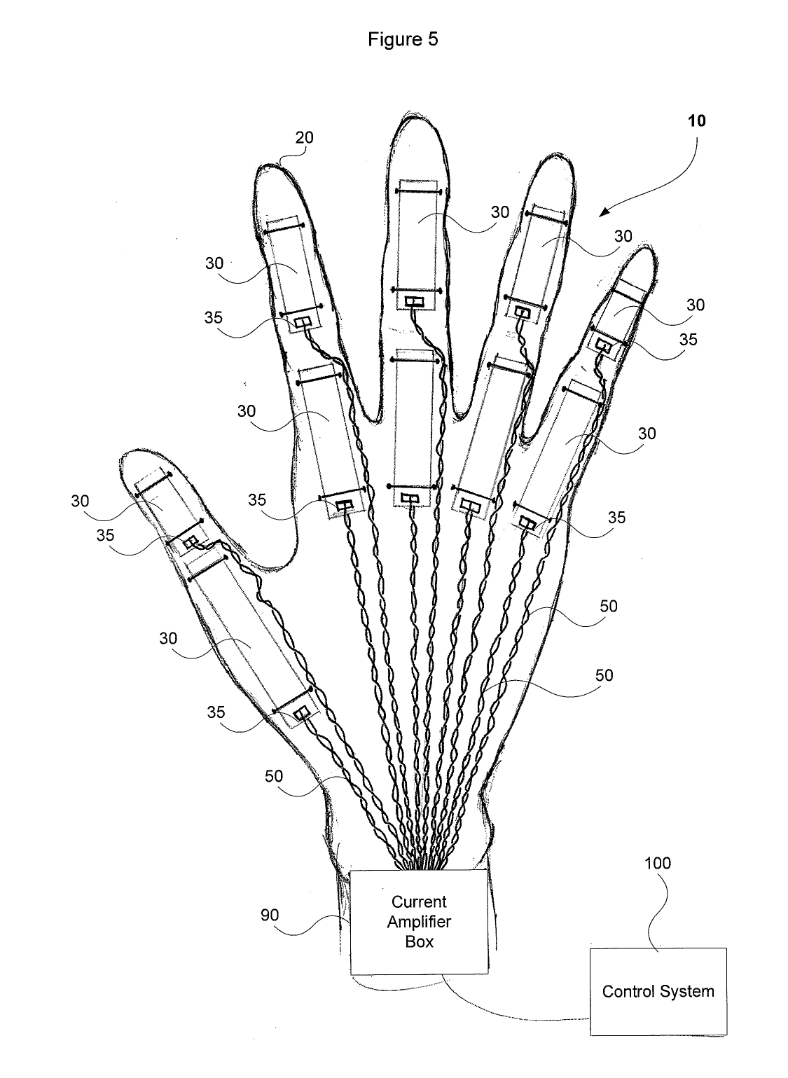

Referring to the drawings, a wearable device 10 for rehabilitation of fingers 5. The device 10 is in the form of a glove which generally comprises a textile material 20 and electroactive polymer (EAP) matrix sets 30. The EAP matrix sets 30 are operatively connected to the textile material 20 to form an EAP actuator for a finger 5 of a wearer. The EAP matrix sets 30 may be thread stitched via sewing thread to the textile material 20 to operatively connect the EAP matrix sets 30 to the textile material 20. The EAP matrix sets 30 may be embedded into the textile material 20. The textile material 20 may be cotton, nylon, polyester and spandex. FIG. 1 depicts an EAP glove 10 with one EAP matrix set 30 while FIG. 5 depicts an EAP glove 10 with two EAP matrix set 30. The EAP matrix set(s) 30 are positioned such that each spans across a finger joint.

A rigid material 40 is used as a force transmission from the electronic EAP 30 to the finger tip. The rigid material 40 is preferably a metal rod such as aluminum rod. An elastic ring 60 releasably connects the EAP actuator 30 to the finger tip. The finger tip is inserted through the elastic ring 60 during use. The elastic ring 60 is preferably an elastic fabric tubing or rubber band. A button 25 attaches the metal rod 40 to the ring 60. This is also for safety reasons. If the force is too large, the button 25 can separate from the metal rod 40 to the finger 5. A movable joint 45 located at the base of the EAP matrix set 30 allows the user to bend their finger 5.

An attachment 70 releasably connects the DC-DC transfer 80 onto the wrist. The attachment 70 is preferably a webbing. The DC-DC transfer 80 is a current amplifier 90 and a high voltage direct current (HVDC) power supply. The conductive material 35 is a compliant electrode to electrically connect the wire cable 50 to the electronic EAP 30.

EAP materials convert electrical energy to mechanical movement in order to provide repetitive, active-assisted movement. EAPs offer attractive properties of energy transduction from the electrical to the mechanical form for actuation. EAPs are classified into two major groups. Ionic EAPs are activated by an electrically driven diffusion of ions and molecules. Ionic polymer metal composites (IPMC) and gel-polymers are ionic EAPs. Electronic EAPs are activated by an electrical field. Electron irradiated (PVDF TrFE), dielectric elastomers (DE), electrostrictive polymer artificial muscle (EPAM), electrorheological fluids are electronic EAPs. The two groups of EAPs include several types of materials which operate in accordance with different principles and properties.

Ionic EAPs (IPMCs) consist of two electrodes and an electrolyte. Materials of this type are activated by an electrically driven diffusion or mobility of ions and molecules. The length of ionic EAPs is 35 to 55 mm, width of 10 mm and thickness of <1 mm.

To fabricate ionic EAPs, the first step is to roughen the material surface where it will serve as an effective electrode. This involves sandblasting or sandpapering the surface of the polymer in order to increase the surface area density where platinum salt penetration and reduction occurs, as well as ultrasonic cleaning and chemical cleaning by acid boiling (HCI or HNO3, low concentrates).

The second step is to incorporate the ion exchanging process using a metal complex solution such as tetra-amine platinum chloride hydrate as an aqueous platinum complex([Pt(NH3)4]Cl2 or [Pt(NH3)6]Cl4) solution. Although the equilibrium condition depends on the type of charge of the metal complex, such complexes were found to provide good electrodes. The immersion and stirring time is typically more than 1 h.

The third step is referred to as an initial platinum compositing process. This is to reduce the platinum complex cations to the metallic state in the form of nanoparticles by using effective reducing agents such as an aqueous solution of sodium or lithium borohydride (5%) at favourable temperature (i.e. 60° C.). Platinum black-like layers deposit near the surface of the material. The final step (surface electroding process) is intended to effectively grow Pt (or other metals) on top of the initial Pt surface to reduce the surface resistivity. Therefore, an additional amount of platinum is plated by the following process on the deposited Pt layer.

A 240 ml aqueous solution of the complex([Pt(NH3)4]Cl2 or [Pt(NH3)6]Cl4) containing 120 mg of Pt and add 5 ml of the 5% ammonium hydroxide solution (pH adjustment) is prepared.

The plating amount is determined by the content of Pt in the solution. A 5% aqueous solution of hydroxylamine hydrochloride and a 20% solution of hydrazine monohydrate is prepared.

The polymer is placed in the stirring Pt solution at 40° C. 6 ml of the hydroxylamine hydrochloride solution and 3 ml of the hydrazine solution are added every thirty minutes.

In the sequence of addition, the temperature is gradually raised to 60° C. for four hours. Grey metallic layers will form on the membrane surface. At the end of this process, a small amount of the solution is sampled and boiled with the strong reducing agent (NaBH4) to check the end point. Other metals (or conducting mediums) which are successfully used include palladium, silver, gold, carbon, graphite and carbon nanotubes. The use of electroplating is found to be very convenient.

For ionic EAPs, the final actuation displacement is around 60 mm/force: 3-4 g). The temperature increase is very mild and the textile material can be used as an insulator for safely.

The bending mechanism of an IPMC actuator is electro-osmosis. Under a low electrical potential imposed across the thickness of fabricated film, fixed ions redistribute, mobile ions migrate within the ion exchangeable polymer membrane, and cations combines with water molecules move to the cathode side. The mobile ions make the electrolyte.

Therefore bending occurs due to differential contraction and expansion of the outermost remote fibers of a film. Water movement may also play a significant role in the actuation. In the case of cation exchange membranes, the strip of perfluorinated ionic polymer membrane bends toward the anode under the influence of an electric potential.

To fabricate electronic EAPs (DE actuator), the elastomer film undergoes automated biaxial pre-stretching. The films are manually coated with compliant electrodes. The pre-stretched elastomer film is manually wrapped around the fully compressed telescope-spring core. The film is laterally fixed on the core.

The DE spring roll actuator is an active spring with adaptive stiffness. An elastomer film is used that is incompressible, isotropic, and has quasi-linear behavior under the conditions of passive equilibrium, free-strain under isomeric activation and blocking force under isometric activation. The free-strain and blocking force are two major characteristics for such an actuator. By varying the applied activation voltage and the actuator's boundary condition, the DE is actuated.

The length of the electronic EAPs is 45 mm, the width is 15 mm and the thickness is 10 mm.

For electronic EAPs, the final actuation displacement is 20 mm/force: 7.2N). A protective layer with transparent plastics is placed onto the surface of the EAP glove. Therefore, electronic EAP is enclosed in a shell of the transparent plastics. The shell provides safety from the high voltage required by the electronic EAP. There is minimal increase of temperature because the electronic EAP consumes very little energy. About 2 Watts is required for each Electronic EAP actuator)

Each finger 5 of the wearer has a corresponding EAP actuator. The force to move the fingers 5 is provided from the EAP matrix sets 30 of the EAP actuators. Each EAP actuator is connected by wire cables 50 to an electrical power source. Each EAP actuator is individually controlled by computer software in a control system 100 where the electrical signals transmitted to the EAP actuators are controlled. A design and control circuit in the control system 100 is also used to control the actuation of the EAP actuators.

The EAP actuators are not in tubular form, however, they permit expansion and contraction to enable movement of the finger about the finger joints. The EAP actuators exert adequate and appropriate force on the fingers 5. The size and dimension of each EAP matrix set 30 may correspond to a finger muscle or finger joint. In other words, each EAP matrix set 30 is contoured to the respective finger joint it is positioned against. For example, for a finger 5, there may be three EAP matrix sets 30. For a hand where there are five fingers, there may fifteen EAP matrix sets 30 in total. The EAP matrix sets 30 are not structurally joined to each other and operate independently.

The EAP matrix sets 30 completely surround the textile material 20 or covers a single surface of the textile material 20 so long as there is no direct contact between the EAP matrix sets 30 and the skin of the wearer. The single surface may the underside of the glove 10 or the palm side of the glove 10.

The EAP glove 10 is a robotic therapy device used by stroke patients for rehabilitation of their fingers 5 and to provide finger muscle training. The EAP glove 10 is generally suitable for people with reduced mobility of the hand due to upper limb paralysis and peripheral nerve injury. Also, training for fine movement of fingers is provided by the EAP glove 10. The EAP glove 10 provides optimal rehabilitation for stroke patients as it can facilitate highly repetitive, active-assisted movement training, reduce impairment with greater convenience and portability. The EAP glove 10 optimizes finger muscle training for stroke patients by allowing them to have daily treatment without frequent assistance from therapists. Therapists are assisted by the EAP glove 10 when conducting intensive and safe rehabilitation programmes with more quantitative and reproducible training motions. Patients do not have to travel to a hospital to use the EAP glove 10, and may use the EAP glove 10 similar to wearing clothes for daily use.

The EAP glove 10 facilitates the relative movement between two portions of an object, and facilitates the bending or deforming of an object or a joint. The EAP glove 10 enables movement of joints especially finger joints in a human body.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

We claim:

1. A wearable device for daily finger rehabilitation, the device comprising:
a textile material; and
electroactive polymer (EAP) matrix sets operatively connected to the textile material to form an EAP actuator for a finger;
wherein at least one EAP matrix set corresponds to a finger joint of the finger for movement of the finger about the finger joint.

2. The wearable device according to claim 1, further comprising five finger sheaths and wherein each finger sheath has EAP matrix sets corresponding to all the finger joints of a finger to assist each muscle of the finger.

3. The wearable device according to claim 1, wherein the EAP matrix sets are ionic or electronic.

4. The wearable device according to claim 1, wherein each finger of the wearer has a corresponding EAP actuator.

5. The wearable device according to claim 1, wherein each EAP actuator is individually controlled by software.

6. The wearable device according to claim 1, wherein each EAP actuator is connected by a wire to an electrical power source and controlled by a computer.

7. The wearable device according to claim 1, wherein the textile material is made from any one from the group consisting of: cotton, nylon, polyester and spandex.

8. The wearable device according to claim 1, wherein the EAP matrix sets are thread stitched to the textile material to operatively connect the EAP matrix sets to the textile material.

9. The wearable device according to claim 1, wherein the EAP matrix sets completely surround the textile material or covers a single surface of the textile material.

10. The wearable device according to claim 1, wherein the wearable device is in the form of a glove.
